(19) United States
(12) Patent Application Publication
(10) Pub. No.: US 2016/0188826 A1
(43) Pub. Date: Jun. 30, 2016

(54) SYSTEM AND METHOD FOR PROVIDING CUSTOMIZED TRIAGE

(71) Applicant: KONINKLIJKE PHILIPS N.V., EINDHOVEN (NL)

(72) Inventors: EUGENE NELSON SCARBERRY, TRAFFORD, PA (US); SARAH LYNNE KUCHMA, GREENSBURGH, PA (US); ROBERT EMMETT KEARNEY, CARNEGIE, PA (US); LOUIS WELTY HIENER, II, PITTSBURGH, PA (US); RAYMOND CHARLES VASKO, JR., TURTLE CREEK, PA (US); TIMOTHY DIXON, PITTSBURGH, PA (US)

(21) Appl. No.: 14/970,838

(22) Filed: Dec. 16, 2015

Related U.S. Application Data
(60) Provisional application No. 62/096,602, filed on Dec. 24, 2014.

(51) Int. Cl. G06F 19/00

(52) U.S. Cl. CPC G06F 19/345; G06F 19/3418; G06F 19/363

(57) ABSTRACT

A method for triaging a respondent includes: providing a quality of life related query to the respondent; receiving a response to the query; determining the response was indicative of a person potentially suffering from disorder sleep; providing information regarding disorder sleep; providing a demographic related query; receiving a response to the demographic related query; determining a particular demographic group for which the respondent should be associated; providing a symptom related query based on the particular demographic group; receiving a response to the symptom related query; determining the response was indicative that the respondent suffers from the symptom; determining a disease that corresponds to the symptom; providing information regarding the disease; determining the respondent's location; and providing information related to a sleep expert near the respondent's location.

### CROSS-REFERENCE TO RELATED APPLICATIONS

This patent application claims the priority benefit under 35 U.S.C. §119(e) of U.S. Provisional Application No. 62/096,602, filed on Dec. 24, 2014, the contents of which are herein incorporated by reference.

### BACKGROUND OF THE INVENTION

1. Field of the Invention

The present invention pertains generally to methods and systems for triaging a person potentially suffering from one or more diseases, and more particularly, to a system and method for identifying, educating, and motivating a person likely suffering from one or more sleep disorders to seek professional diagnosis and treatment.

2. Description of the Related Art

It is well known that many individuals (i.e., approximately 30-40% of the US population) suffer from one or more sleep disorders and thus suffer from disorder sleep (i.e., low quality/quantity sleep). However, disorder sleep may result from several causes and thus is not typically a simple one problem disease and one solution therapy. Instead, a person suffering from disorder sleep may suffer, for example, from one or more of sleep disordered breathing, periodic leg movement syndrome/restless leg syndrome, and insomnia. A major difficulty in treating such disorders is obtaining a diagnosis that a patient is suffering from one or more of such disorders. Commonly a person suffering from a sleep disorder is unaware that anything is seriously wrong as symptoms of such disorders are non-specific. (i.e., a patient often suffers from a general malaise as opposed to a distinct symptoms). Accordingly, a complex process is typically needed in order to provide a coordinated diagnosis and therapy so that the patient's problems are completely resolved.

Many individuals suffer from disordered breathing during sleep. Obstructive sleep apnea (OSA), which affects millions of people throughout the world, is a common example of such disordered breathing. OSA is a condition in which sleep is repeatedly interrupted by an inability to breathe. This inability to breathe is typically caused by intermittent obstruction of a person's airway. Obstruction of the airway is believed to be due, at least in part, to a general relaxation of the muscles which stabilize the upper airway segment. When these muscles relax, the surrounding tissues collapse thereby obstructing the airway.

Those afflicted with OSA experience sleep fragmentation and intermittent cessation of ventilation during sleep with potentially severe degrees of oxyhemoglobin desaturation. These symptoms may be translated clinically into extreme daytime sleepiness, cardiac arrhythmias, pulmonary-artery hypertension, congestive heart failure and/or cognitive dysfunction. Other consequences of OSA include right ventricular dysfunction, carbon dioxide retention during sleep, as well as wakefulness, and continuous reduced arterial oxygen tension. Sleep apnea sufferers may be at risk for excessive mortality from these factors as well as by an elevated risk for accidents while driving and/or operating potentially dangerous equipment.

A person may suffer from the adverse effects discussed above even where only partial obstruction of the airway occurs. Partial obstruction of the airway typically results in shallow breathing referred to as a hypopnea. Other types of disordered breathing include upper airway resistance syndrome (UARS) and vibration of the airway, such as vibration of the pharyngeal wall, commonly referred to as snoring. It is also known that snoring can accompany closure of the airway leading to UARS, hypopnea, or apnea. Thus, snoring serves as an indicator that the patient is experiencing abnormal breathing.

Milder cases of disordered breathing may be treated using an oral appliance such as a mandibular advancement device (MAD). A MAD is generally structured to pull a patient's lower jaw (mandible) forward relative to their upper jaw (maxilla), which in turn, opens the patient's airway.

More severe cases of disordered breathing may be treated by applying a continuous positive air pressure (CPAP) to the patient's airway. This positive pressure effectively “splints” the airway, thereby maintaining an open passage to the lungs. It is also known to provide a positive pressure therapy in which the pressure of gas delivered to the patient varies with the patient's breathing cycle, or varies with the patient's effort, to increase the comfort to the patient. One such pressure support technique is referred to as bi-level pressure support (e.g., BiPAP® bi-level pressure support), in which the inspiratory positive airway pressure (IPAP) delivered to the patient is higher than the expiratory positive airway pressure (EPAP) delivered to the patient. Other pressure support therapies and/or ventilation therapies are known and employed for the treatment of disordered breathing.

Pressure support and ventilation therapies may be non-invasively delivered to the patient. A patient interface device, generally placed on the face of a patient, facilitates the delivery of a flow of breathing gas from a pressure/flow generating device (e.g., a ventilator, pressure support device, etc.) to the airway of the patient. Patient interface devices include nasal prongs, nasal masks, full nasal/oral masks, and total face masks, among others. The pressure of the flow of breathing gas delivered to the patient is generally derived through a titration process administered by a sleep technician. The pressure at which the flow of breathing gas is delivered, herein referred to as the “therapeutic pressure”, is generally between 4 cm H₂O and 40 cm H₂O, although other pressures may be employed.

Many individuals suffer from periodic leg movement syndrome/restless leg syndrome which in most instances is treated by one or more medications. In some instances, however, lower leg stimulation is used as a treatment.

Many individuals suffer from insomnia which may be treated with one or more medications and/or cognitive behavioral therapy. Such therapy generally seeks to educate the patient on what are good and bad habits related to behaviors in regard to sleep and ways to improve such behavior.

In many patients (over 10% of the US population) these conditions (i.e., sleep disordered breathing, periodic leg movement syndrome/restless leg syndrome, insomnia) can co-exist and need to be treated separately.

Regardless of the disorder, the best treatment of a patient's potential sleep disorder(s) requires a proper diagnosis of the full complexity of their disorder(s). The correct diagnosis can lead to the proper therapeutic intervention. The correct intervention (e.g., therapy, appliance, medication, etc.) will not help the patient if the patient does not understand the seriousness of their disorder and/or the potential benefits (e.g., improvement in energy level) of following the prescribed treatment. Patient's lacking such understanding are generally less motivated to comply with a prescribed treatment. Conventional approaches aim to rescue patients once they show signs of disuse of the particular intervention. Such approach is thus heavily reliant on feedback from the typically under-informed patients themselves. As a result, such approach typically results in only a very small percentage (typically<50%) of the total symptomatic patients being diagnosed, prescribed a treatment, and compliant with their therapy, and thus realizing the maximum potential benefits of such therapy.

Applicant is unaware of any prior art systems or methods which provide for diagnosing, educating/motivating, and/or treating a patient in a complete streamlined fashion.

Accordingly, a need exists for an improved system and method which provides for diagnosing, educating/motivating, and/or treating a patient in a streamlined fashion which overcomes these and other problems associated with known methods.

### SUMMARY OF THE INVENTION

Embodiments of the present invention provide a smooth coordination of the entire patient care cycle, implemented earlier and better aligned than known approaches. Interactions with a user (i.e., a potential patient) which commence the question/education/ motivation process are made early in the process and can be made through a variety of ways which are tailored to fit the user. Through such interactions, embodiments of the present invention can then determine the type/location of the initial testing and what approach for intervention will be best to be used.

As one embodiment of the present invention, a method for triaging a respondent is provided. The method comprises: providing a quality of life related query to the respondent; receiving a response to the query; determining the response was indicative of a person potentially suffering from disorder sleep; providing information regarding disorder sleep; providing a demographic related query; receiving a response to the demographic related query; determining a particular demographic group for which the respondent should be associated; providing a symptom related query based on the particular demographic group; receiving a response to the symptom related query; determining the response was indicative that the respondent suffers from the symptom; determining a disease that corresponds to the symptom; providing information regarding the disease; determining the respondent's location; and providing information related to a sleep expert near the respondent's location.

Providing information regarding disorder sleep may comprise: providing information regarding serious consequences of disorder sleep; and providing information regarding treatments of causes of disorder sleep.

Providing a number of demographic related queries may comprise providing queries requesting one or more of the respondent's: age, sex, height, and weight.

Providing a number of demographic related queries may comprise providing a query related to the education level of the respondent.

One or more of the symptom query, the information regarding the disease, or the information related to a sleep expert near the respondent's location may be dependent on the educational level of the respondent.

Providing information regarding the disease may comprise providing information regarding treatments of the disease.

Determining the respondent's location may comprise: providing a location related query; receiving a response to the location related query; and determining the respondent's location based on the response to the location related query.

Determining the respondent's location may comprise detecting the location using information related to an internet connection of the respondent or gps data related to the respondent.

Providing information related to a sleep expert near the respondent's location may comprise providing one or more of the sleep expert's: contact information, location information, or practice information.

Providing information related to a sleep expert near the respondent's location may comprise: providing information regarding scheduling an appointment with the sleep expert; and scheduling an appointment for the respondent with the sleep expert.

Providing information related to a sleep expert near the respondent's location may comprise transmitting the information via an electronic communication.

As another aspect of the present invention, a system is provided. The system comprises a questionnaire including a plurality of queries including: a quality of life related question to determine if a respondent potentially suffers from disorder sleep; a demographic related question; and an identification-related questions to determine a disease or condition the respondent may have. The system further comprises a processing unit for receiving and processing a plurality of responses to the plurality of queries and an output unit. The processing unit determines the following based on the plurality of responses: whether further testing of such respondent is needed and provides advice regarding the nature of such testing, whether treatment of such respondent is needed and provides advice regarding the nature of such treatment. The output unit is structured to communicate an output of the processing unit to the respondent or a caregiver of the respondent.

The demographic related question may comprise an education related question to determine how best to communicate with the respondent. The plurality of queries may be provided in an electronic format. The output may comprise an electronic file.

These and other objects, features, and characteristics of the present invention, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention

### BRIEF DESCRIPTION OF THE DRAWINGS

FIG. 1 illustrates an operational process of a method according to one embodiment of the present invention; and

FIG. 2 is a schematic view of a system according to an example embodiment of the present invention.

### DETAILED DESCRIPTION OF EXEMPLARY EMBODIMENTS

Directional phrases used herein, such as, for example, left, right, clockwise, counterclockwise, top, bottom, up, down, and derivatives thereof, relate to the orientation of the elements shown in the drawings and are not limiting upon the claims unless expressly recited therein.

As employed herein, the term “number” shall mean one or more than one and the singular form of “a”, “an”, and “the” include plural referents unless the context clearly indicates otherwise. As employed herein, the statement that two or more parts are “connected” or “coupled” together shall mean that the parts are joined together either directly or joined together through one or more intermediate parts. Further, as employed herein, the statement that two or more parts are “attached” shall mean that the parts are joined together directly.

As employed herein, the term “disordered breathing” shall refer to breathing abnormalities which may occur while a patient is one or both of asleep or awake, examples of which may include, without limitation, increased upper airway resistance (including snoring), upper airway resistance syndrome (UARS) and obstructive sleep apnea-hypopnea syndrome (OSAHS). As employed herein, the term “sleep disorder” shall refer to any disease (e.g., without limitation, sleep disordered breathing, periodic leg movement syndrome/restless leg syndrome, insomnia, etc.) which adversely affects a person's sleep.

As employed herein, the term “disorder sleep” shall refer to the sleep quality of a person suffering from one or more sleep disorders. As employed herein, the term “user” shall refer to a person whom is engaged by or with a system or person carrying out the methods described herein. As employed herein, the term “patient” shall refer to the person requiring treatment for disordered breathing. As employed herein, the term “therapist” shall refer to the person or persons determining and providing the treatment or system for treating the patient.

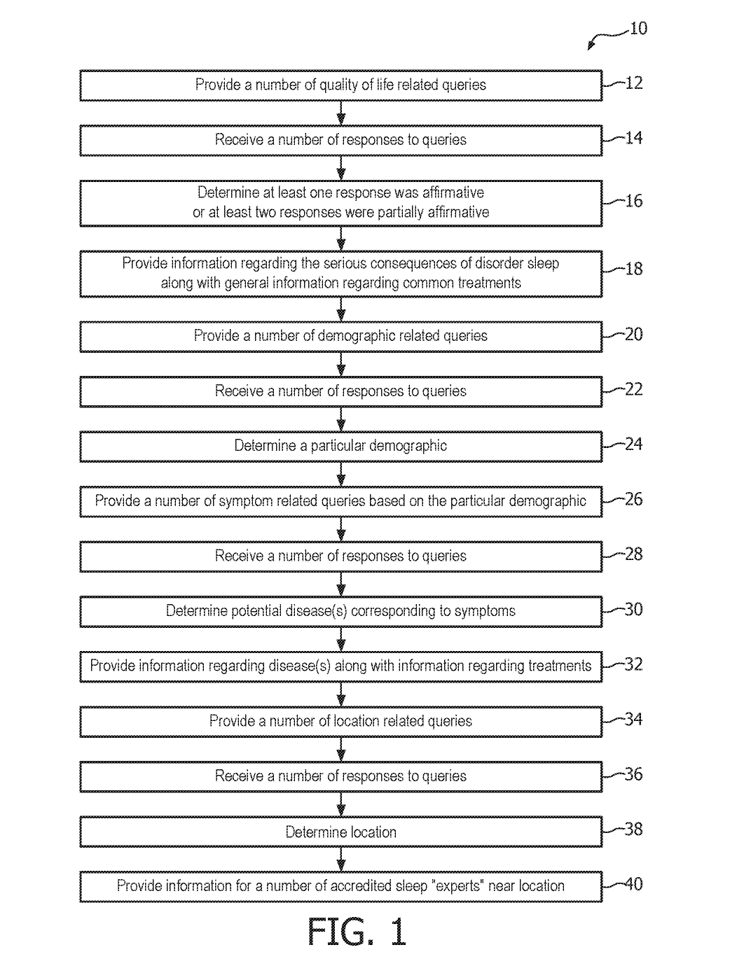

FIG. 1 illustrates an operational process of a method 10 according to one embodiment of the present invention is illustrated. As will be discussed further below, such method 12 includes interactions with a user (i.e., a potential patient) that may be carried out in numerous ways without varying from the scope of the present invention. For example, without limitation, such interactions in the method may be carried out via a face to face interaction, via an internet based application accessed via a suitable computing device (e.g., without limitation, personal computer, tablet, smartphone), via a kiosk-type arrangement, via a touchtone phone, or via any other suitable arrangement.

Referring to FIG. 1, in a first step 12, a number of “quality of life” questions or queries are presented to a user (i.e., a potential patient). As used herein, the term “quality of life” in regard to such queries shall refer questions regarding the presence or absence of elements in a user's life which cause a detrimental effect. Such “quality of life” questions are intended to identify if the user is potentially suffering from disorder sleep. As the executive function of a person suffering from disorder sleep typically suffers from a lack of quality sleep, some examples of such questions are as follows:
Do you feel like you are living in a fog?
Is waking up difficult in the morning after going to bed at a decent hour?
Do you fall asleep while watching television during normal waking hours?
Do you fall asleep while operating an automobile or at other odd times?
Do you suffer from frequent colds and/or infections?

A response for each such query is subsequently received in step 14. An affirmative response (i.e., yes or always) or partially affirmative response (e.g., sometimes, often) are considered an indication that the user is likely suffering from disorder sleep. In order to keep the user engaged, it is desirable to minimize the quantity and complexity of questions asked in this initial step. As shown in step 16, once it is determined that an affirmative response or more than one partially affirmative response has been received, it is determined that there is a good probability that the user suffers from disorder sleep and thus likely suffers from one or more sleep disorders. If a user does not make any affirmative or partially affirmative responses after responding to numerous (e.g., without limitation 10), the user is then provided with a salutation message (not shown) thanking them for their time along with an indication that they appear to be sleeping well or some other suitable parting statement.

From these initial steps, it is to be appreciated that a user who is likely suffering from disorder sleep, a person to which the method is intended to identify and attract, is generally identified using a minimal quantity of questions (e.g., potentially as few as 1 or 2), and thus is likely to not lose interest and disengage from the method (i.e., cease participation). In contrast, a user who consistently answers negative to such quality of life related queries most likely does not suffer from disorder sleep, is thus not a target of the method, and thus is not a lost opportunity if they lose interest and disengage from the method, so presenting them with a larger quantity of queries is not a concern.

Referring next to step 18, once it has been determined that the user likely suffers from disorder sleep, the user is then provided information regarding some serious potential consequences of disorder sleep (e.g., without limitation, stroke, heart attack, automobile accident) along with information regarding common treatments thereof (e.g., adjusting sleeping position form lying on back to another position, mouthpiece, weight loss). Such step 18 serves a dual-purpose. First, by providing the user with some examples of serious, attention grabbing, potential consequences of disorder sleep, the user is more likely to stay engaged with the method (and potential subsequent actions). Second, by providing the user with examples of potential non-intimidating treatments that could prevent such serious consequences, the user is both educated and motivated to continue along the learning/treatment path, and thus continue engagement with the method.

In order to provide a more personalized interaction with the user, now considered a “likely-patient” since advancing beyond the initial queries presented in step 12, the user is next presented with a number of demographic related queries in step 20 which are then received in step 22. Once again, keeping the amount of queries the user is required to answer minimized while still being able to personalize the interaction is a major objective so as to maintain the attention of the user. Accordingly, such demographic related questions are typically limited to ascertaining the user's age (or age range in which their age falls), their sex (i.e., male or female), and their approximate height and weight. Such queries may be made as: distinct queries, one or more composite queries, or a combination of both. For example, a user may be simply asked several distinct queries (e.g., what is your height? Weight? Sex? Age? Etc.). Alternatively, a user may be asked what description of multiple provided descriptions best describes them (e.g., without limitation, middle aged average weight male, petite young female, obese elderly male, etc.).

As a further alternative, the user may be first asked to identify their sex (i.e., male or female) and then, based on their sexual identification, be asked to pick a group that best describes them (e.g., without limitation, young and fit, middle aged and overweight, elderly and average weight, etc.). From the responses received in step 22 to such queries made in step 20, a particular demographic to which the user is a member is determined, as shown in step 24, and used to personalize further queries to best fit the particular demographic of the user.

As an additional mechanism for providing a personalized interaction with the user, a further query provided in step 20 may be used to ascertain how and/or at what communication level would be best to communicate with the user. For example, the user may be prompted to identify the level of their education (i.e., high school, college, post-grad, etc.) and/or how they might prefer to continue the interaction with the method (e.g., without limitation, continue with the existing means, receive a personal phone call, e-mail, etc.). From such additional query or queries both the ongoing interactions with the user can be better tailored to fit to one or more of the user's education level (i.e., presented at a level that is not too simple or too complex) and/or how the user prefers to interact/communicate.

Next, in step 26, a number of symptom related queries is provided to the user based on their determined demographic. In other words, the user is presented with queries related to symptoms most commonly suffered by members of their particular demographic. For example, if it was determined in step 24 that the user was an obese male, over 50 (a demographic group in which approximately 85% of disorder sleep sufferers have obstructive sleep apnea), the user may be presented with queries regarding lack of sex drive and/or general grumpiness (common symptoms of sleep apnea in obese males, over 50). As another example, if it has been determined that the user is an adolescent female of normal weight, the user may be presented with queries regarding depression or headaches (i.e., common symptoms of UARS (upper airway resistance syndrome)/and or mild apnea in adolescent females of normal weight). It is to be appreciated that the object of step 26 is to generally identify one or more diseases (e.g., without limitation, sleep disordered breathing, periodic leg movement syndrome/restless leg syndrome, insomnia, etc.) which may cause the disorder sleep that was previously determined to be a problem from which the patient likely suffers.

While desirable to potentially identify all such diseases from which the patient may suffer, it is generally acceptable for purposes of the present invention to merely identify one potential disease and then motivate/assist the patient toward seeing a sleep professional (e.g., without limitation, pulmonologist, ear nose and throat (ENT) surgeon, internist, sleep lab physician) in regard to such disease as such professional would likely be better positioned to confirm such disease and/or the existence of any other disease(s). Such result is obviously preferable to causing a user to disengage from the method by presenting too many queries related to possible symptoms. Responses to such symptom related queries provided in step 26 are received in step 28.

Next, in step 30, from the number of responses received at step 28, at least one disease is determined from which there is at least a reasonable likelihood that the user is suffering. Then, at step 32, the user is then provided information regarding some serious potential consequences of the at least one disease (e.g., without limitation, severe depression, migraine headaches, irritable bowel syndrome) along with information regarding benefits of potential treatment (e.g., without limitation, changing sleep position, weight loss, a mouthpiece) of such disease. Similar to the more general information previously provided in step 18, the information provided in step 30 serves a dual-purpose. First, by providing the user with some examples of serious consequences of the particular disease or diseases which may be affecting the user, the user is more likely to stay engaged with the method (and potential subsequent actions). Second, by providing the user with examples of potential non-intimating treatments that could prevent such serious consequences, the user is both educated and motivated to continue along the learning/treatment path, and thus continue with the method.

Having thus determined at least one sleep disorder from which the patient likely suffers, a number of location queries is provided to the user in step 34 in order to determine the locality in which the user would likely be seeking treatment. As an example, the user may be asked to provide the zip code in which they reside and/or where they would likely want to seek treatment. In such case, a response to such query would then be received at step 36 and from such response the location of the user would then be determined at step 38. As an alternative, a general location of the user may be detected using information from their internet connection or gps data from their electronic device if available. In such instances, the user may then be presented a query at step 34 as to whether they would like to use such detected location or would like to provide an alternative location.

It is to be appreciated that while the number of location related queries presented at step 34 could have been presented previously to the user, by providing such queries later in the method the number of queries presented to the user is minimized as only the minimal queries needed at a particular time to optimize the interaction are presented to the user. In other words, if a query can wait to be presented to a user at a later time, it is.

As a final step 40 in the method 10, the user is provided with information related to a number of accredited sleep “experts” near their location. As an example, such “experts” may include, without limitation, pulmonologists, ear nose and throat (ENT) surgeons, internists, sleep lab physicians or any physician certified by the American Professional Sleep Society (APSS). Such information may include, for example, without limitation, contact information, location information, practice information, etc. Such information may be provided to the user via a number of suitable means. For example, if the user previously indicated a preferred communication means (e.g., e-mail, phone, regular mail, etc.), such information may be transmitted via such preferred communication means. Further, the user may be provided with the option to have such local sleep experts contacted directly to schedule an appointment for a formal diagnosis. It is to be appreciated that the general purpose of such step 40 is to effectively hand off the user to an expert in a manner as simple as possible so as to maximize the likelihood the user will see and expert. Accordingly, such step may range from simply providing some general information regarding one or more sleep experts to actually scheduling an appointment for the user with the sleep expert.

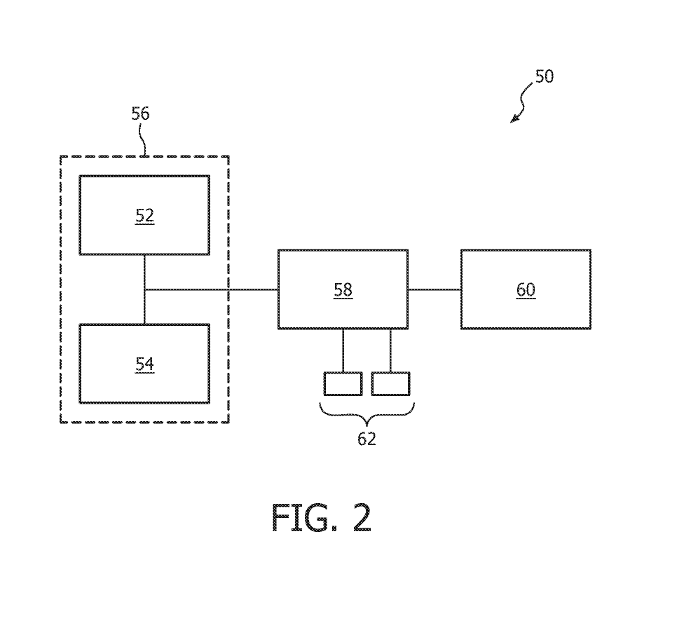

Having thus described an exemplary embodiment of a method in accordance with the present invention, an example embodiment of a system 50 for carrying out such method will be briefly described in conjunction with the arrangement showed schematically in FIG. 2. System 50 includes one or more of an input device 52 and an output device 54, or a combination input/output device 56 in communication with a processing device 58. Processing device 58 is any suitable device for sending queries, receiving responses thereto, and making determinations in accordance with the method previously described. In carrying out such method, processor 58 may employ one or more of internal memory (not numbered) stored thereon or a suitable external memory 60. One or more further communication devices 62 may further be provided in communication with processing device 58 for providing information to a user, as will be discussed below.

In an example embodiment, system 50 comprises a kiosk-type unit which may be provided in a pharmacy or other suitable location for interacting with users potentially suffering from disorder sleep. In such application, a touchscreen is preferably employed as the combination input/output device 56 for providing queries and information to the user and receiving responses therefrom. External memory 60 may be disposed on the kiosk or may be remotely located elsewhere (e.g., without limitation, at a remote location accessed via the internet or other suitable connection). In such arrangement one or more of a printer, local wireless signal (e.g., without limitation, WiFi) or other suitable communications device may be provided as one or more further communications devices 62 disposed in or on the kiosk for providing information to the user in a transportable form for subsequent review at a later time.

In another example, the processor 58 and memory 60 may be located at a remote location which is accessed by a user via the internet or other suitable communication pathway by a user's device (e.g., without limitation, smartphone, tablet, computer, etc.) or via a conventional telephone.

From the foregoing description it is to be appreciated that the present invention provides for methods and systems of interacting with an individual who may be suffering from one or more diseases that cause disorder sleep in a manner that minimizes the time and energy needed to complete the process while also educating and motivating the user to seek treatment form a professional. Though such minimization, education, and motivation, the likelihood of the individual seeking, and following through with treatment is greatly increased as opposed to existing methods which are commonly tedious and impersonal.

Although the invention has been described in conjunction with disorder sleep, it is to be appreciated that the general concepts described herein may be readily applied to other conditions.

Although the invention has been described in detail for the purpose of illustration based on what is currently considered to be the most practical and preferred embodiments, it is to be understood that such detail is solely for that purpose and that the invention is not limited to the disclosed embodiments, but, on the contrary, is intended to cover modifications and equivalent arrangements that are within the spirit and scope of the appended claims.

In the claims, any reference signs placed between parentheses shall not be construed as limiting the claim. The word “comprising” or “including” does not exclude the presence of elements or steps other than those listed in a claim. In a device claim enumerating several means, several of these means may be embodied by one and the same item of hardware. The word “a” or “an” preceding an element does not exclude the presence of a plurality of such elements. In any device claim enumerating several means, several of these means may be embodied by one and the same item of hardware. The mere fact that certain elements are recited in mutually different dependent claims does not indicate that these elements cannot be used in combination.

What is claimed is:

1. A method for triaging a respondent, the method comprising:
providing a quality of life related query to the respondent;
receiving a response to the query;
determining the response was indicative of a person potentially suffering from disorder sleep;
providing information regarding disorder sleep;
providing a demographic related query;
receiving a response to the demographic related query;
determining a particular demographic group for which the respondent should be associated;
providing a symptom related query based on the particular demographic group;
receiving a response to the symptom related query;
determining the response was indicative that the respondent suffers from the symptom;
determining a disease that corresponds to the symptom;
providing information regarding the disease;
determining the respondent's location; and
providing information related to a sleep expert near the respondent's location.

2. The method of claim 1, wherein providing information regarding disorder sleep comprises:
providing information regarding serious consequences of disorder sleep; and
providing information regarding treatments of causes of disorder sleep.

3. The method of claim 1, wherein providing a number of demographic related queries comprises providing queries requesting one or more of the respondent's: age, sex, height, and weight.

4. The method of claim 1, wherein providing a number of demographic related queries comprises providing a query related to the education level of the respondent.

5. The method of claim 4, wherein one or more of the symptom query, the information regarding the disease, or the information related to a sleep expert near the respondent's location is dependent on the educational level of the respondent.

6. The method of claim 1, wherein providing information regarding the disease comprises providing information regarding treatments of the disease.

7. The method of claim 1, wherein determining the respondent's location comprises:
providing a location related query;
receiving a response to the location related query; and
determining the respondent's location based on the response to the location related query.

8. The method of claim 1, wherein determining the respondent's location comprises detecting the location using information related to an internet connection of the respondent or gps data related to the respondent.

9. The method of claim 1, wherein providing information related to a sleep expert near the respondent's location comprises providing one or more of the sleep expert's: contact information, location information, or practice information.

10. The method of claim 1 wherein providing information related to a sleep expert near the respondent's location comprises:
providing information regarding scheduling an appointment with the sleep expert; and
scheduling an appointment for the respondent with the sleep expert.

11. The method of claim 1 wherein providing information related to a sleep expert near the respondent's location comprises transmitting the information via an electronic communication.

12. A system comprising:
(a) a questionnaire comprising a plurality of queries including:
(1) a quality of life related question to determine if a respondent potentially suffers from disorder sleep;
(2) a demographic related question; and
(3) an identification-related questions to determine a disease or condition the respondent may have;
(b) a processing unit for receiving and processing a plurality of responses to the plurality of queries, wherein the processing unit determines the following based on the plurality of responses:
whether further testing of such respondent is needed and provides advice regarding the nature of such testing, and
whether treatment of such respondent is needed and provides advice regarding the nature of such treatment, and
(c) an output unit structured to communicate an output of the processing unit to the respondent or a caregiver of the respondent.

13. The system of claim 12, wherein the demographic related question comprises an education related question to determine how best to communicate with the respondent.

14. The system of claim 12, wherein the plurality of queries are provided in an electronic format.

15. The system of claim 12, wherein the output comprises an electronic file.
